(19) United States
(12) Patent Application Publication
(10) Pub. No.: US 2020/0387950 A1
(43) Pub. Date: Dec. 10, 2020

(54) Method And Apparatus For Cosmetic Product Recommendation

(71) Applicant: ELC MANAGEMENT LLC, Melville, NY (US)

(72) Inventors: Branden Gus Ciranni, Levittown, NY (US); Jia Jun Li, Woodhaven, NY (US); Grace Tan, Brooklyn, NY (US); Tae Woon Lee, New York, NY (US); John Joseph Healy, Basking Ridge, NJ (US)

(21) Appl. No.: 16/435,023

(22) Filed: Jun. 7, 2019

(51) Int. Cl. G06Q 30/06; G06N 20/00; G06K 9/62; G06F 9/54

(52) U.S. Cl. CPC G06Q 30/0631; G06F 9/54; G06K 9/6215; G06N 20/00

(57) ABSTRACT

Methods and systems for recommending products, including receiving an image for analysis, requesting analysis of the image for word annotation, receiving annotated words generated as one or more tags, embedding the one or more tags as word vectors, comparing the word vectors to product descriptions in a database, and retuning a product recommendation based on the comparison.

### FIELD

The present disclosure relates generally to methods and apparatus for providing custom recommendations, more particularly, for cosmetic product recommendation based on one or more images.

### BACKGROUND

Customized or personalized product recommendations, such as personal care or cosmetic products, are growing in popularity. However, existing methods of providing product recommendations can involve long surveys and questionnaires to gain information on user preference. For example, existing methods of fragrance selection either require in-person consultations, or do not allow for immediate virtual recommendation of a fragrance product without long surveys. As such, there is a need for an improved process for providing product recommendation to consumers.

### SUMMARY

Embodiments herein provide systems and methods for providing product recommendations based on an image.

In one embodiment, a computer-implemented method of recommending products includes receiving an image for analysis, requesting analysis of the image for word annotation, receiving annotated words generated as one or more tags, creating a first set of trained word vectors corresponding to the one or more tags using a processor to map each word from the one or more tags to a corresponding vector in n-dimensional space, creating one or more sets of trained word vectors corresponding to one or more product descriptions in a database using a processor to map each word in the product descriptions to corresponding vectors in n-dimensional space, calculating a distance between the first set of trained word vectors and each of the one or more sets of trained word vectors corresponding to the product descriptions, comparing the calculated distances to determine a closest distance representing the best match between the received image and the product descriptions, and automatically generating a product recommendation based on the comparison.

### BRIEF DESCRIPTION OF THE DRAWINGS

FIG. 1 illustrates an exemplary image-based product recommendation method according to embodiments herein;

FIG. 2 shows an exemplary flow diagram of the product recommendation method of FIG. 1;

FIG. 3 shows a system for providing image-based product recommendation, according to an embodiment herein;

FIG. 4 shows an exemplary computing device on which at least one or more components or steps of the invention may be implemented, according to an embodiment herein;

FIG. 5 shows an exemplary process flow of the image-based product recommendation method of FIG. 1 and FIG. 2;

FIG. 6 shows a flow diagram of a process for identifying and matching an image to products to provide a product recommendation, according to an embodiment herein; and

FIG. 7 shows an exemplary user interface for implementing the product recommendation method, according to an embodiment herein.

### DETAILED DESCRIPTION

Embodiments of the invention will be described herein with reference to exemplary network and computing system architectures. It is to be understood, however, that embodiments of the invention are not intended to be limited to these exemplary architectures but are rather more generally applicable to any systems where image-based product recommendation may be desired.

As used herein, “n” may denote any positive integer greater than 1.

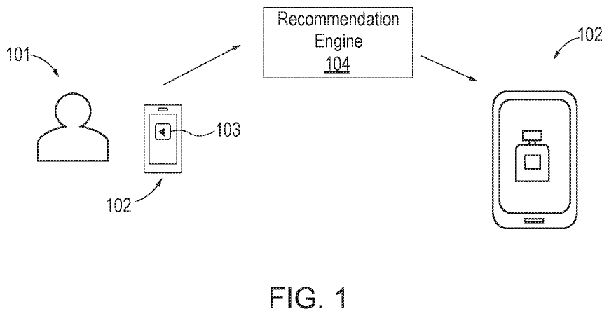

Referring to FIG. 1 showing an overview of a product recommendation method according to an embodiment herein, a user 101 accesses a user interface 103 on user device 102 to use recommendation engine 104. User 101 can upload an image using device 102 via the user interface 103. The user interface 103 can be a website, an application on the user device 102, or any suitable means now known or later developed. The user interface 103 interacts with the recommendation engine 104 and receives at least one product recommendation based on the uploaded image from the recommendation engine 104. The product recommendation(s) is shown on the display of the user device 102. The user device 102 can be a mobile device, a computer, or any suitable device capable of interacting with recommendation engine 104. Details of the methods and systems for implementing image-based product recommendation are further delineated below.

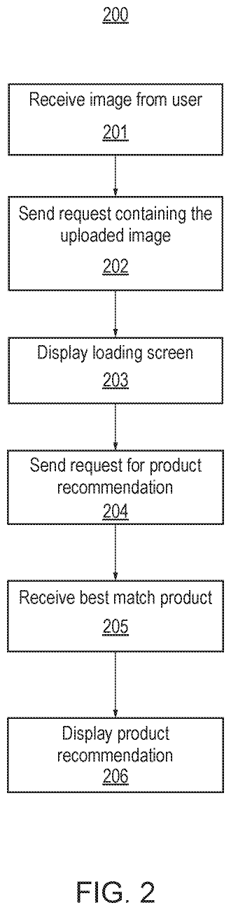

FIG. 2 shows a flow diagram of a process of the product recommendation method of FIG. 1. Specifically, a process 200, implemented at the user interface 103 of FIG. 1, for receiving an image and providing at least one product recommendation based on the image. At step 201, a user interface 103 receives an image from a user 101 (e.g., at user device 102). The image can be captured at the user device using an imaging device or stored at the user device for upload via the user interface. The image is relevant to the product, type of product, or features of the product for which the user is requesting recommendations. For example, if the product is a fragrance, the image can represent characteristics of or relating to the fragrance (e.g., floral, clean, leather, etc.) that is of interest to the user. At step 202, the uploaded image and a request is sent by the user interface 103 to a recommendation engine 104. At step 203, the user interface 103 displays a loading screen to user 101 at the user device 102. At step 204, the user interface 103 sends a request for a product recommendation based on the uploaded image to the recommendation engine 104. At step 205, the user interface 103 receives a best match for a product recommendation from the recommendation engine 104. At step 206, the best match product is displayed on the user device 102 as the product recommendation based on the uploaded image.

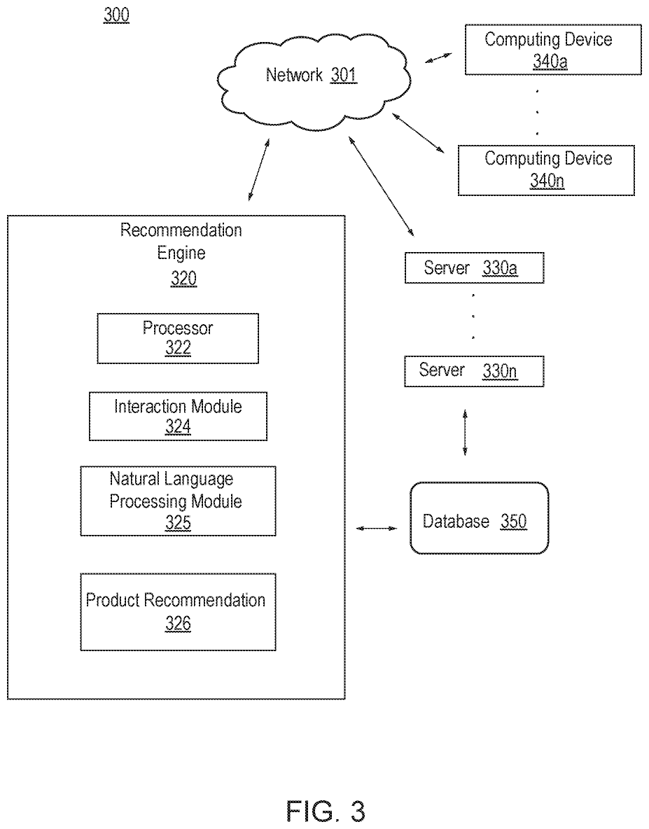

FIG. 3 shows an exemplary embodiment of a system on which one or more steps of the image-based product recommendation method described above can be implemented. The system 300 includes a recommendation engine 320 coupled to a database 350. The recommendation engine 320 is also coupled to one or more servers 330a . . . 330n, and one or more computing devices 340a . . . 340n over network 301. The network 301 may be a local area network (LAN), a wide area network (WAN) such as the Internet, a cellular data network, any combination thereof, or any combination of connections and protocols that will support communications between the recommendation engine 320, servers 330a . . . 330n, computing devices 340a . . . 340n, and database 350 in accordance with embodiments herein. Network 301 may include wired, wireless, or fiber optic connections. The recommendation engine 320 (e.g., recommendation engine 104 described above) may be an Application Programming Interface (API) that resides on a server or computing device, configured to be in communication with one or more databases and/or one or more devices (e.g., printer, point-of-sales device, mobile device, etc.) to store and retrieve user or product information. Servers 330a . . . 330n may be a management server, a web server, any other electronic device or computing system capable of processing program instructions and receiving and sending data, or combinations thereof. Computing devices 340a . . . 340n may be a desktop computer, laptop computer, tablet computer, or other mobile devices. In general, computing device 340a . . . 340n may be any electronic device or computing system capable of processing program instructions, sending and receiving data, and communicating with one or more components of system 300, recommendation engine 320, and servers 330a . . . 330n via network 301. Database 350 may include product information, user information, and any other suitable information. Database 350 can be any suitable database, such as relational databases, including structured query language (SQL) databases, for storing data. Stored data can be structured data which are data sets organized according to a defined scheme. Database 350 is configured to interact with one or more components of system 300, such as recommendation engine 320 and one or more servers 330a . . . 330n. System 300 can include multiple databases.

The recommendation engine 320 may include at least one processor 322. The processor 322 configurable and/or programmable for executing computer-readable and computer-executable instructions or software stored in a memory and other programs for implementing exemplary embodiments of the present disclosure. Processor 322 may be a single core processor or multiple core processor configured to execute one or more of the modules. For example, the recommendation engine 320 can include an interaction module 324 configured to interact with one or more users and or external devices, e.g., other servers or computing devices. The recommendation engine 320 can include a Natural Language Processing (NLP) module 325 for running a NLP algorithm to convert and/or compare data related to one or more received images. The recommendation engine 320 can also include a product recommendation module 326 to provide one or more product recommendations based on the NLP module results. The recommendations can then be displayed on the user interface and/or sent to one or more external devices, and/or stored on one or more databases. In some embodiments, if the user selects one or more of the products from the recommendation, the interaction module 324 can retrieve information for each product and allow the user to purchase the product(s) through the user interface.

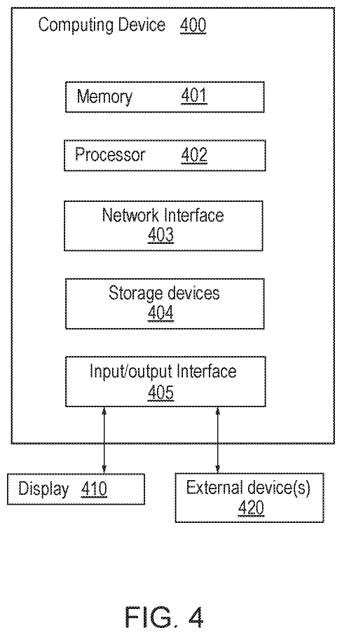

FIG. 4 shows a block diagram of an exemplary computing device with which one or more steps/components of the invention may be implemented, in accordance with an exemplary embodiment. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 401 of the computing device 400 may store computer-readable and computer-executable instructions or software (e.g., applications and modules described above) for implementing exemplary operations of the computing device 400. Memory 401 may include a computer system memory or random access memory, such as DRAM, SRAM, EDO RAM, and the like. Memory 401 may include other types of memory as well, or combinations thereof. The computing device 400 may also include configurable and/or programmable processor 402 for executing computer-readable and computer-executable instructions or software stored in the memory 401 and other programs for implementing exemplary embodiments of the present disclosure. Processor 402 may be a single core processor or multiple core processor configured to execute one or more of the modules described in connection with recommendation engine 320. The computing device 400 can receive data from input/output devices such as, external device 420, display 410, and computing devices 340a . . . 340n, via input/output interface 405. A user may interact with the computing device 400 through a display 410, such as a computer monitor or mobile device screen, which may display one or more graphical user interfaces, multi touch interface, etc. Input/output interface 405 may provide a connection to external device(s) 420 such as a keyboard, keypad, and portable computer-readable storage media such as, for example, thumb drives, portable optical or magnetic disks, and memory cards, etc. The computing device 400 may also include one or more storage devices 404, such as a hard-drive, CD-ROM, or other computer readable media, for storing data and computer-readable instructions and/or software that implement exemplary embodiments of the present disclosure (e.g., modules described above for the recommendation engine 320). The computing device 400 can include a network interface 403 configured to interface with one or more network devices via one or more networks, for example, Local Area Network (LAN), Wide Area Network (WAN) or the Internet through a variety of connections including, but not limited to, standard telephone lines, LAN or WAN links, broadband connections, wireless connections, controller area network (CAN), or some combination of any or all of the above.

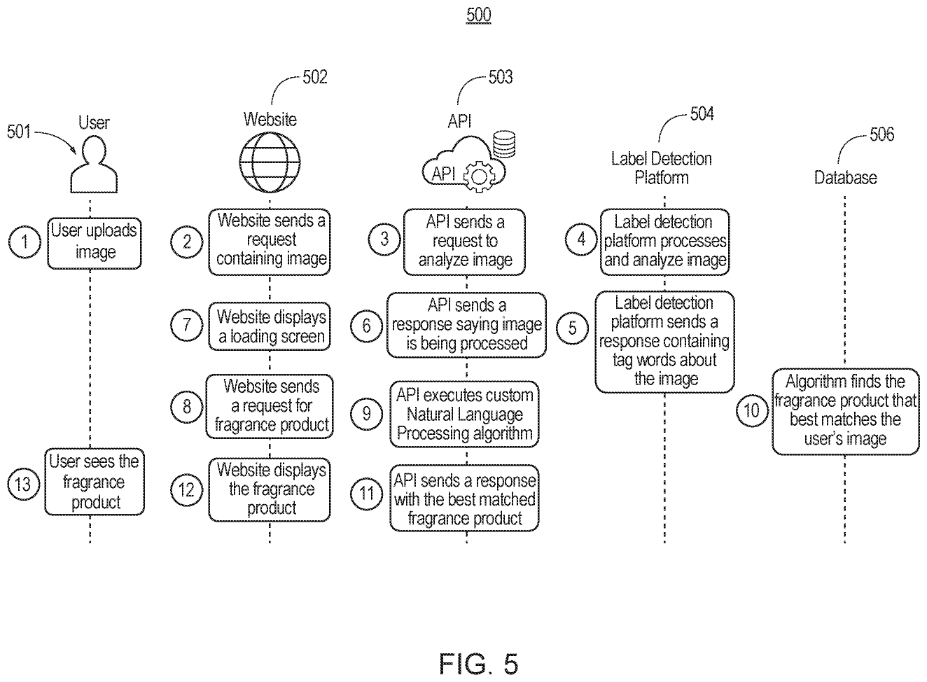

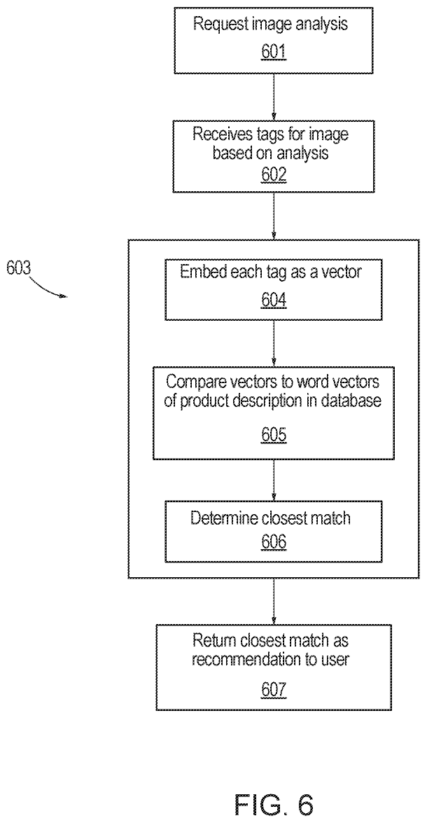

FIG. 5 shows an exemplary process flow between the various components of a system (e.g., system 300) for implementing the method described herein. At step 1, user 501 uploads an image to a user interface such as website 502. At step 2, website 502 receives the user image and sends a request containing the image to API 503. Web site 502 can be implemented and configured for interaction with API 503 by various languages and methods, such as React, Hypertext Markup Language (HTML), Cascading Style Sheets (CSS), JavaScript (JS), or combinations of these languages. At step 3, API 503 send the request to a label detection platform 504 to analyze the image. The label detection platform 504 is configured to automatically perform image annotation, extract image attributes, perform optical character recognition (OCR), and/or content detection to generate word labels or tags for the image. For example, if a user uploads an image of a cup of coffee, the label detection platform 504 analyzes the image and can return words such as coffee, mug, and beans as tags. The tags generated by label detection platform 504 is returned to the API 503 at step 5. An exemplary label detection platform that is commercially available is the Google Cloud Vision available from Google®. At step 6, the API 503 sends a response to website 502 with the status of the request as being in process. At step 7, the website displays a loading screen to user 501. At step 8, the website sends a request to the API for a product recommendation based on the image (e.g., fragrance recommendation). At step 9, the API 503 executes a custom NLP algorithm on the tags received from the label detection platform 504. Details of the NLP algorithm are delineated below in FIG. 6. At step 10, the API 503 communicates with database 506 and compares the tags to the product descriptions in the database 506 to return the best matched product based on the uploaded image. At step 11, the API 503 sends a response to website 502 containing the best matched product. At step 12, the website displays the best matched product as the recommendation. At step 13, the user 501 sees the recommendation on the display of the user device.

Website 502, API 503, and label detection platform 504 can be implemented on the same or different server in system 300 shown in FIG. 3. API 503 can be implemented as recommendation engine 320 in FIG. 3, according to an embodiment herein. The user device can be implemented as one of the computing devices shown in FIG. 3 and FIG. 4. Languages that can be used in implementing one or more API used in embodiments herein are Python, JavaScript, or any other programming language.

FIG. 6 shows a flow chart of the NLP algorithm performed at API 503 in FIG. 5 via an NLP module such as NLP module 325 of FIG. 3, according to an embodiment herein. At step 601, the API sends an image analysis request to a label detection platform or any other image detection platform. At step 602, the tags for the image are received in the form of words or characters. At step 603, the NLP algorithm performs steps 604-606. This NLP algorithm uses pretrained word vectors for word representation. A commercially available example of word vectors is the set of those trained using the GloVe (Global Vectors) unsupervised learning algorithm available from Stanford University. At step 604, for every word in the list of image tags, that word is mapped to its corresponding vector in n-dimensional space, where n may be any positive integer, preferably more than 100. This functions like a dictionary lookup. At step 605, the following comparison is made: for every product in the database, apply the same reasoning as in step 604, and transform words into vectors. A first list of word vectors corresponding to the image tags, and a second list corresponding to the description words are generated. Then, for every word vector in the image tags, he distance to the “closest” word vector in the description words is determined, where closeness is determined by a spatial definition of distance, such as the Euclidean or cosine distance. Given the distance between each word and its closest neighbor, the NLP algorithm finds the average of these distances, and this is established as the closeness between an image and the product in question. At step 606, the closest average of distances is determined to be the best product match based on the image uploaded by the user. At step 607, the best match is then returned to the website or user interface as the product recommendation. The best match may be one or more products.

Table 1 below shows an exemplary representation of two word lists and the cosine distance between words generated by the NLP algorithm described above.

TABLE 1
Exemplary representations of cosine distance between words

| Image | Keywords in Product Description | | | | | | |
|---|---|---|---|---|---|---|---|
| Caption | invigorating | layer | legs | light | lightly | man | neck |
| camera | −0.041 | 0.263 | 0.395 | 0.493 | 0.162 | 0.437 | 0.352 |
| man | −0.048 | 0.197 | 0.436 | 0.493 | 0.305 | 1.000 | 0.433 |
| smiling | 0.049 | 0.005 | 0.393 | 0.269 | 0.225 | 0.501 | 0.347 |
| suit | −0.189 | 0.240 | 0.301 | 0.462 | 0.213 | 0.445 | 0.337 |
| tie | −0.091 | 0.230 | 0.422 | 0.325 | 0.203 | 0.402 | 0.428 |
| wearing | −0.121 | 0.152 | 0.490 | 0.465 | 0.325 | 0.595 | 0.518 |

The rows in Table 1 represent an exemplary set of tags generated by the label detection platform 504 from an uploaded image. The columns in Table 1 represent keywords from the product descriptions in the database. The values in the table represent the distance between a word generated based on the uploaded image (each row) and a word from the product description (a column), generated by the NLP algorithm described above. In one example, the numbers shown in Table 1 are calculated as cosine similarity. Each cell calculated as follows:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

where A and B are the vectors corresponding with the row and column words respectively. The higher the value, the closer in distance between the words, and the higher the relevance and match between the words. For example, the cell corresponding to row “man” and column “man” has a value of 1.00 for being an exact match. As another example, the cell corresponding to row “suit” and column “invigorating” has a value of −0.189, representing a low correlation between the two words.

As described above, the NLP algorithm finds the average of these distances, and this average is established as the closeness between an image and the product in question. This process can be repeated for each product description in the database. Based on the calculated averages, the closest average of distances is determined to be the best match, and the product associated with the best match is then returned to the website or user interface as the product recommendation.

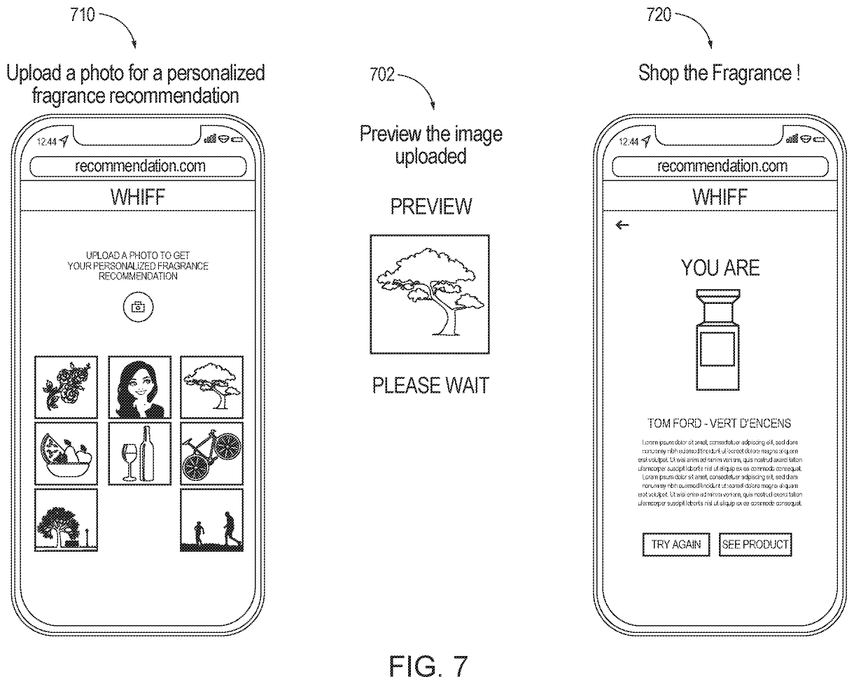

FIG. 7 shows an example of the user interface for implementing the product recommendation method described herein. As shown in 710, the user device displays an interface for uploading an image via a website (or device application). An image 702 is uploaded through the interface. In this example, a user is seeking a fragrance recommendation based on the image. The web site receives the image, and the web site and API perform the steps detailed above in FIGS. 5 and 6. As shown in 720, the fragrance having a description best matched to the tags generated from the image is displayed as the recommended fragrance product on the display of the user device. The user is then able to find more information or purchase the product from the user device.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of recommending products, comprising:
receiving an image for analysis;
requesting analysis of the image for word annotation;
receiving annotated words generated as one or more tags;
creating a first set of trained word vectors corresponding to the one or more tags using a processor to map each word from the one or more tags to a corresponding vector in n-dimensional space;
creating one or more sets of trained word vectors corresponding to one or more product descriptions in a database using a processor to map each word in the product descriptions to corresponding vectors in n-dimensional space;
calculating a distance between the first set of trained word vectors and each of the one or more sets of trained word vectors corresponding to the product descriptions;
comparing the calculated distances to determine a closest distance representing the best match between the received image and the product descriptions; and
automatically generating a product recommendation based on the comparison.

2. The method of claim 1, wherein creating the first set of trained word vectors comprises using an unsupervised learning algorithm for generating vector representations from one or more words.

3. The method of claim 1, wherein creating one or more sets of trained word vectors corresponding to one or more product descriptions comprises using an unsupervised learning algorithm for generating vector representations from one or more words.

4. The method of claim 1, wherein calculating the distance comprises determining a cosine similarity between two word vectors.

5. The method of claim 4, wherein the two word vectors include a word vector from the first set of trained word vectors and a word vector from a set of the one or more sets of trained word vectors corresponding to the product descriptions.

6. The method of claim 5, further comprising calculating an average distance for the first set of trained vectors and each of the one or more sets of trained word vectors corresponding to the product descriptions.

7. The method of claim 6, wherein comparing the calculated distances comprises comparing the average distances to determine the closest distance.

8. The method of claim 1, wherein the products are cosmetic products.

9. The method of claim 8, wherein the cosmetic product is a fragrance.

10. A product recommendation system, comprising:
a user interface;
at least one communication network;
a label detection platform; and
at least one application programming interface (API) for:
receiving an image for analysis from the user interface;
requesting analysis of the image for word annotation from the label detection platform;
receiving annotated words generated as one or more tags from the label detection platform;
creating a first set of trained word vectors corresponding to the one or more tags using a processor to map each word from the one or more tags to a corresponding vector in n-dimensional space;
creating one or more sets of trained word vectors corresponding to one or more product descriptions in a database using a processor to map each word in the product descriptions to corresponding vectors in n-dimensional space;
calculating a distance between the first set of trained word vectors and each of the one or more sets of trained word vectors corresponding to the product descriptions;
comparing the calculated distances to determine a closest distance representing the best match between the received image and the product descriptions;
automatically generating a product recommendation based on the comparison; and
transmitting the product recommendation to the user interface over the at least one communication network.

11. The system of claim 10, further comprising one or more user devices configured to communicate over the at least one network.

12. The system of claim 11, wherein the one or more user devices communicates with the one or more API via the user interface.

13. The system of claim 12, wherein the product recommendation is displayed on the one or more user devices via the user interface.
